(19) United States
(12) Patent Application Publication
(10) Pub. No.: US 2025/0045591 A1
(43) Pub. Date: Feb. 6, 2025

(54) Synthetic Profiles Using Machine Learning

(71) Applicant: Capital One Services, LLC, McLean, VA (US)

(72) Inventors: Benjamin Eng, Silver Spring, MD (US); John Fields, Henrico, VA (US); Ignacio Espino, Arlington, VA (US); Bryant Yee, Silver Spring, MD (US); Eric Eppler, Baltimore, MD (US)

(21) Appl. No.: 18/228,955

(22) Filed: Aug. 1, 2023

(51) Int. Cl. G06N 3/09; G06N 3/04

(52) U.S. Cl. CPC G06N 3/09; G06N 3/04

(57) ABSTRACT

Methods, systems, and apparatuses are described herein for using machine learning to generate and use synthetic profiles. A computing device may train a machine learning model to generate synthetic user profiles. The computing device may then use the trained machine learning model to generate a plurality of synthetic user profiles based on real user profile information, provide those synthetic user profiles to a quote provider via an API, then average the quotes received from that provider to determine an expected quote for the real user. The computing device may also collect a plurality of quotes from a quote provider based on synthetic user profiles, then train a second machine learning model to estimate quotes by that provider. That trained second machine learning model may be used to estimate quotes for users, and may be re-trained based on real quotes provided by the quote provider at a later time.

### FIELD OF USE

Aspects of the disclosure relate generally to machine learning. More specifically, aspects of the disclosure may provide for use of a machine learning model to generate and use a plurality of synthetic user profiles to test quote providers and use of machine learning models to predict quotes form those quote providers.

### BACKGROUND

Users are generally uncomfortable providing their personal data to entities that are likely to use that information for marketing purposes. For instance, a customer shopping for a new car on the Internet might want to receive an out-the-door price for the car, but might be uncomfortable providing (e.g., via an online form) a dealer their cell phone number because doing so might subject them to endless follow-up calls and marketing pitches. As a result, users often look for ways to gain information (e.g., when browsing the Internet) in a manner which preserves their anonymity and, for instance, allows them to freely comparison shop without being at the mercy of e-mail spam lists, endless marketing calls, and the like. As a simple example, a user might use a second and/or fake e-mail address when signing up to online forms, as doing so generally ensures that their primary e-mail address does not receive marketing materials.

This problem is particularly relevant in the case of online shopping for items and services that require the exchange of detailed personal information, like insurance. For example, users might want to comparison shop online for various insurance providers by asking for quotes from different insurance companies, but might understandably wish to avoid those insurance providers using their personal data for the purposes of e-mail marketing (or, in extreme examples, for doing a hard pull on their credit and/or signing them up for services without permission). That said, while those users might be tempted to provide false information (e.g., fake e-mail accounts, fake address information), this can have unintended consequences: for example, the fake information (e.g., the designation of a different kind of vehicle than the real user actually owns) might result in inaccurate quotes from a quote provider. For example, a user might provide a fake home address when trying to comparison shop for property insurance, but the quote provider might heavily rely on that address when calculating a quote, meaning that the user is likely to receive a largely unrepresentative quote.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to using machine learning models and synthetic user profiles to acquire quote information from different quote providers, then analyze that information for the purposes of providing accurate quotes in a manner that does not disclose personal information about real users. This may include a process whereby quote providers are synthetically tested in a manner that does not disclose user information. For example, a computing device might train a machine learning model to generate synthetic user profiles based on real user data. Those synthetic user profiles might be entirely falsified (e.g., use fake names, fake ages, fake addresses, and the like), but might be substantially similar to a real user's data. For example, for a single real user, fifty different synthetic user profiles might be generated, and each might be different from the user in some way (e.g., one might indicate a different city, one might indicate a different vehicle, but all might have fake names). Those synthetic user profiles might be provided to a quote provider via an Application Programming Interface (API), and various quotes for the synthetic user profiles (that is, the fake users) might be collected. In turn, the received quotes may be analyzed to determine an average quote, which might be substantially similar to the quote that a real user would have received. In other words, while the synthetic user profiles might be different from real user data, they might be averaged out in the aggregate to determine a substantially accurate quote for a real user. In this way, the user is able to receive a useful quote from a quote provider without ever actually disclosing their identity to the quote provider. Additionally and/or alternatively, aspects described herein describe using quotes provided from providers (e.g., those in response to synthetic profiles and/or real user data) for the purposes of training a different machine learning model to estimate quotes for one or more quote providers. A computing device might train this different machine learning model such that users might provide their own data to the machine learning model and receive a synthetic quote that estimates a quote that would be provided by a quote provider. In this manner, the user need not provide the quote provider their details. Moreover, this different trained machine learning model might be improved over time: for instance, the different machine learning model might be informed what the same user actually ends up paying at a later time, and nodes of the machine learning model might be modified (e.g., re-weighted) accordingly.

More particularly, a computing device may be configured to synthetically test quote providers to avoid disclosing user information. The computing device may train, based on training data that comprises a plurality of different sets of user data, a machine learning model to generate synthetic user profiles by modifying, based on the training data, weights associated with one or more nodes of an artificial neural network. The training data may be labeled to indicate whether each of the plurality of different sets of user data represents a real person. The computing device may receive first user data corresponding to a first user and provide, to the trained machine learning model, input comprising the first user data. The computing device may then receive, from the trained machine learning model, output comprising a plurality of different synthetic user profiles. The computing device may replace, in the plurality of different synthetic user profiles, instances of a name of the first user with a second name. Each of the plurality of different synthetic user profiles may comprise a variation of one or more properties of the first user data. The computing device may send, via an API associated with a quote provider, each of the plurality of different synthetic user profiles to the quote provider. The sending of these synthetic user profiles may be obfuscated or otherwise configured to not tip off the quote provider that the profiles are synthetic: for example, the computing device may send each of the plurality of different synthetic user profiles to the quote provider at a different time. The computing device may then receive, from the quote provider and via the API, a plurality of different quotes that each correspond to a different one of the plurality of different synthetic user profiles. The computing device may then determine an average quote for the first user based on, for example, deviations between each of the plurality of different synthetic user profiles and the first user data and/or the plurality of different quotes. The computing device may then cause display, in a user interface, of the average quote.

The synthetic user profiles may comprise various information. For example, at least one of the plurality of different synthetic user profiles may comprise a first address different from a second address indicated in the first user data, a first income level different from a second income level indicated in the first user data, and/or a first traffic infraction history different from a second traffic infraction history indicated in the first user data.

The machine learning model may be further trained based on whether the average quote was correct. For example, the computing device may receive, via the user interface, a difference between the average quote and an amount paid to the quote provider and then may provide, as further training to the trained machine learning model, data based on the difference.

The average quote may be determined using a weighting scheme. For example, the computing device may determine, based on the deviations, a weight for each of the plurality of different quotes, generate a weighted plurality of different quotes by multiplying each of the plurality of different quotes by a corresponding weight, and then sum the weighted plurality of different quotes.

Moreover, a computing device may be configured to implement an artificial intelligence model of quote providers. The computing device may send, to a quote provider, a plurality of different synthetic user profiles generated based on one or more real user profiles. The computing device may then receive, from the quote provider, a plurality of different quotes that each correspond to a different one of the plurality of different synthetic user profiles. The computing device may train, based on training data that comprises the plurality of different quotes and the plurality of different synthetic user profiles, a machine learning model to estimate quotes by modifying, based on the training data, weights associated with one or more nodes of an artificial neural network. Those synthetic user profiles may comprise information such as an identification of a vehicle, an identification of an income level, and/or an identification of a geographic location. The computing device may then receive first user data corresponding to a first user, provide, to the trained machine learning model, input comprising the first user data, and receive, from the trained machine learning model, output comprising a synthetic quote. The synthetic quote may indicate a predicted periodic payment amount, a coverage amount, or similar information about the quote. The computing device may then cause display, in a user interface, of the synthetic quote. The computing device may subsequently receive data indicating an actual amount paid by the user and to the quote provider and then modify, based on the actual amount paid by the user and to the quote provider, the weights associated with the one or more nodes of the artificial neural network. The actual amount paid by the user need not be the same as the synthetic quote: for instance, the weights associated with the one or more nodes of the artificial neural network might be weighted based on a determination that the synthetic quote was wrong in some aspect.

The computing device may determine the actual amount paid by the user in a variety of ways. For example, the computing device may receive, from a transactions database, a transactions history corresponding to the first user and parse the transactions history to identify at least one transaction corresponding to the quote provider. Then, the computing device may determine, based on the at least one transaction, the actual amount paid by the user and to the quote provider. Additionally and/or alternatively, the computing device may receive, via the user interface and from the first user, input comprising the actual amount paid by the user and to the quote provider.

The synthetic user profiles may be generated using a different machine learning model. For example, the computing device may train a second machine learning model to generate synthetic user profiles, provide, to the trained second machine learning model, input comprising second user data, and then receive, from the trained second machine learning model, output comprising the synthetic user profile.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure:

FIG. 3 depicts a system comprising servers (including machine learning servers and transaction servers) and user devices.

FIG. 4 depicts a flow chart comprising steps which may be performed to synthetically test quote providers to avoid disclosing user information.

FIG. 5 depicts a flow chart comprising steps which may be performed to implement an artificial intelligence model of quote providers.

FIG. 6 depicts examples of how real user data might be used to create one or more synthetic user profiles.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, users are generally uncomfortable providing personal data to marketers and others during an online shopping process, in no small part because such data is often used to instigate unwanted e-mails, phone calls, andin extreme examplesfinancial transactions. That said, for services that require quotes (e.g., insurance, car loans, and other sensitive transactions), personal information is often necessary for the purposes of generating an accurate quote. This can force some users into an uncomfortable situation: they might want to comparison shop online for car loans and the like, but the fear of relentless marketing and unauthorized use of personal data can inhibit such comparison shopping.

Aspects described herein remedy these and other issues using large pluralities of synthetic user profiles that are similar to, but different from, real user profiles such that the average of quotes for those synthetic user profiles might provide an approximation of a quote that a user might have received if they provided their real profile data. A machine learning model might be trained to generate synthetic user profiles based on real user data. In turn, that trained machine learning model might generate a plurality of different synthetic user profiles based on data for a real user. Each of these synthetic user profiles might be different from the user in various ways: for example, one might involve a different age, whereas another might involve a different location. These synthetic user profiles might be provided to a quote provider, which might provide quotes based on those synthetic user profiles. Those quotes might be averaged, such that, even though the synthetic user profiles might be different from the user profile, the average of such quotes is substantially similar to what the user would have been quoted if they provided their real data. In this way, the average quote might predict a quote for the user, even though the quote provider might have never been provided the user's real information. The machine learning model might be trained over time as well: for example, if a user later ends up paying more than was originally quoted, then the trained machine learning model might be further trained based on such error.

A further advantage of the process described herein is that one or more second machine learning models might be trained based on real quotes received by quote providers. When quote providers provide quotes (e.g., based on synthetic user profiles, as described above), those quotes might be used to train a second machine learning model to estimate quotes that would be provided by a quote provider. In this manner, the second trained machine learning model might be provided user data and, in response, the second trained machine learning model might output a quote estimate. Moreover, based on a difference between an actual amount paid and the quote estimate, the second machine learning model may be re-trained. In this way, the process of providing synthetic user profile information to quote providers might be used to train machine learning models to predict how those quote providers might respond to real user data without requiring that such real user data be, in fact, provided to those quote providers.

As an example of how the present disclosure may operate, a user might want to shop for a car loan. The user might provide user data, such as their name, address, the car they want to purchase, and the like. That data might be provided to a first trained machine learning model that has been trained to generate synthetic user profiles. In turn, the first trained machine learning model might output a plurality of different synthetic user profiles: one might have a slightly different address, another might have a slightly different model year of vehicle, and the like. That plurality of synthetic user profiles might be provided to a quote provider, which might respond with a plurality of different quotes that are all different from one another. Those quotes might be averaged (and e.g., weighted based on the degree of difference between each synthetic user profile and the user data) to determine an average quote from the user. In this way, the user need not provide their user data, but might nonetheless receive a reasonably accurate quote for the car loan. Those quotes might also be used to train a second machine learning model to estimate quotes from the quote provider. At some later time, the actual amount paid by the user may be determined. For example, the user might provide that information to the system, and/or the information might be gleaned from transaction data or e-mail data. Then, the first trained machine learning model and/or the second trained machine learning model may be further trained based on any differences between the actual amount paid and either or both of the average quote and/or any estimated quotes provided by the second trained machine learning model. In this manner, the machine learning models continually improve, over time, in their ability to generate synthetic user profiles and/or quotes.

Aspects described herein improve the functioning of computers by improving the process of machine learning and data security. As detailed above, data security can be paramount in the context of certain activities, such as shopping for a car loan. The process described herein effectuates a form of data security by using machine learning models to generate synthetic data and by providing such synthetic data to third parties for the purposes of receiving quotes that, when averaged and/or otherwise processed in the aggregate, can be used to determine a quote for a particular user without ever exposing the personal data of that user. Moreover, the process described herein effectuates a form of data security by generating machine learning models that estimate quotes of a quote provider without requiring that real user data be, in fact, provided to that quote provider in a manner that might expose that user to unwanted marketing or other unauthorized use of their personal information. This process also leverages the ability of computing devices to submit quotes via an API in a manner that can be analyzed over time without necessarily. For instance, by carefully (and, e.g., randomly) submitting synthetic user profile along with real user data (as requested by users), this process uses computerized processes to ensure that quote providers are not able to distinguish real and fake profiles and provide maximally accurate quotes.

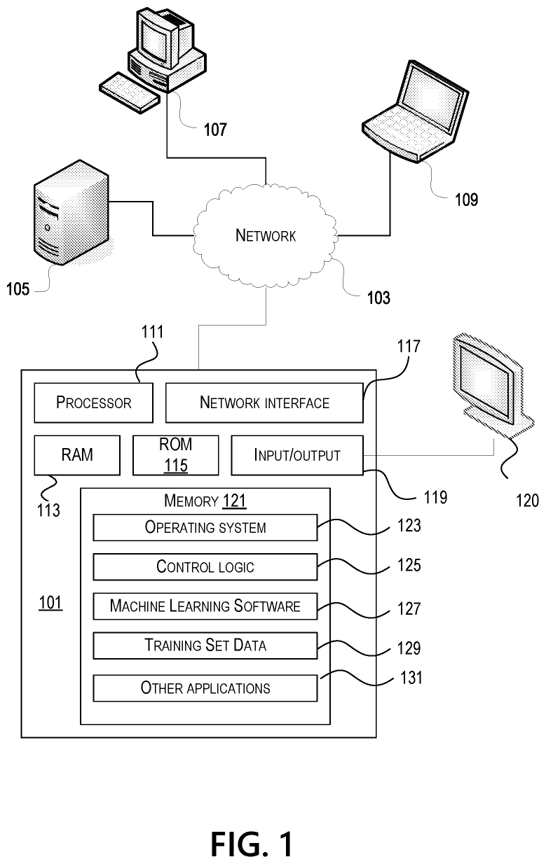

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

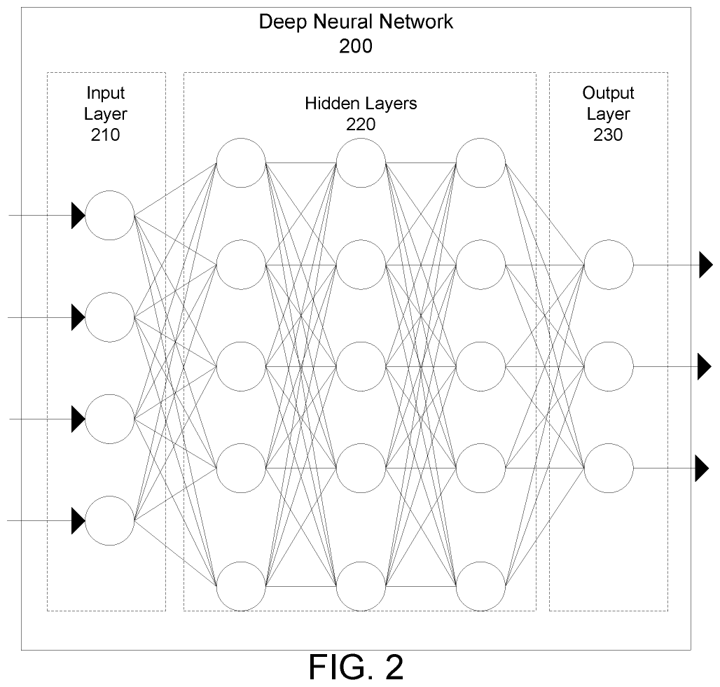

FIG. 2 illustrates an example of a deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network architecture 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

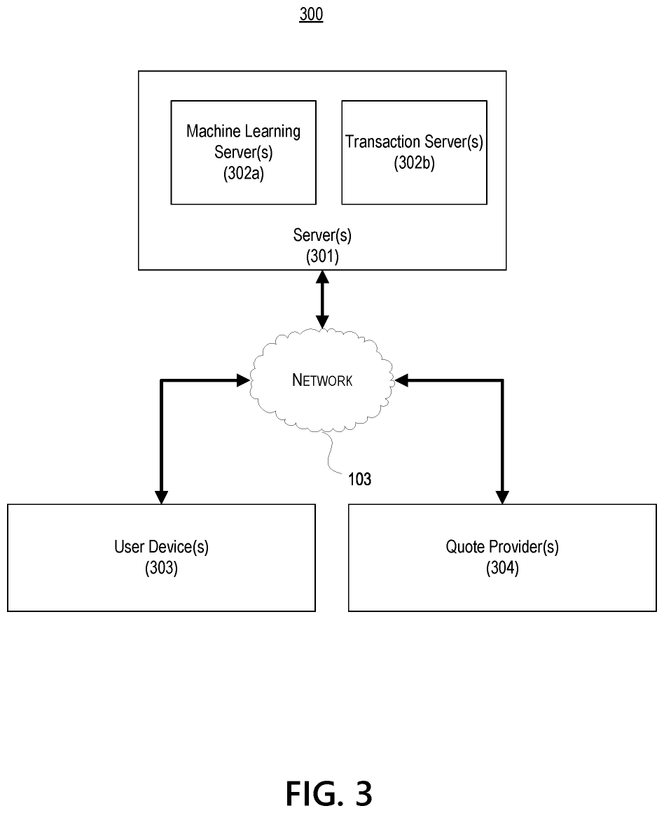

FIG. 3 depicts a system 300 comprising one or more servers 301 (that include one or more machine learning servers 302a and one or more transaction servers 302b) communicatively coupled, via the network 103, to one or more user devices 303 and one or more quote providers 304. The one or more servers 301, the one or more user devices 303, and/or the one or more quote providers 304 may comprise computing devices, such as computing devices that comprise one or more processors and memory storing instructions that, when executed on the one or more processors, cause the performance of one or more steps. The one or more servers 301, the one or more user devices 303, and/or the one or more quote providers 304 may comprise any of the devices depicted with respect to FIG. 1, such as one or more of the computing devices 101, 105, 107, and/or 109.

The servers 301 may comprise one or more computing devices configured to, for example, train and execute machine learning models (such as by executing the machine learning software 127), to provide input and receive output from those machine learning models, receive and/or transmit data via the network 103 (and, e.g., via APIs), and the like. For example, at least one of the one or more servers 301 may be configured to send real user data and/or synthetic user profiles to quote providers and receive, in response, one or more quotes from those quote providers. As yet another example, at least one of the one or more servers 301 may be configured to determine an average quote amount by weighting and/or averaging quotes received from quote providers.

The one or more machine learning servers 302a may be configured to manage machine learning. For instance, the one or more machine learning servers 302a may be configured to train machine learning models, provide input to those trained machine learning models, and/or receive output from those trained machine learning models. This may involve storing data and/or managing (e.g., executing) applications associated with the deep neural network architecture 200. The one or more machine learning servers 302a may be configured to train a machine learning model by causing one or more nodes of an artificial neural network to be weighted based on training data. The one or more machine learning servers 302a may be configured to provide input to that trained machine learning model by, for example, providing input to an input node of the artificial neural network. The one or more machine learning servers 302a may be configured to receive output from that trained machine learning model by, for example, receiving data from an output node of the artificial neural network.

The one or more transaction servers 302b may be configured to store transaction data for a user. The one or more transaction servers 302b may, for example, store a history of financial transactions (e.g., payment card transactions) conducted by a user. Those transactions may indicate, for example, a merchant, a price, a date and/or time, or the like. Those transactions may be associated with one or more users.

The one or more servers 301 may additionally and/or alternatively comprise other forms of servers. For example, one or more of the servers 301 may be configured to transmit and/or receive data via an API and to/from the one or more quote providers 304. Additionally and/or alternatively, one or more of the servers 301 may comprise an e-mail server that is configured to store e-mail data.

Though the one or more machine learning servers 302a and the one or more transaction servers 302b are shown as separate, these servers may execute on one or more of the same servers of the one or more servers 301. For example, the same server that trains a machine learning model may additionally manage a list of transactions conducted by a user. In this manner, the one or more servers 301 may be configured in a wide variety of ways to suit the needs of different organizations and/or users.

The one or more user devices 303 may comprise laptops, desktops, smartphones, or similar computing devices. The one or more user devices 303 may be configured to display user interfaces and receive user input via those user interfaces. For example, the one or more user devices 303 may be configured to allow a user to provide information about themselves (that is, input user data), to receive indications of one or more quotes provided by a quote provider, or the like.

The one or more quote providers 304 may comprise one or more servers associated with the provider of quotes for, e.g., purchases, car loans, and the like. The one or more quote providers 304 may be configured to, in response to user data, output a quote. For example, when provided personal data about one or more users, the one or more quote providers 304 may be configured to output, via one or more APIs, a quote for a car loan, for insurance, or the like. The one or more quote providers 304 might, in some circumstances, be untrusted in the sense that, for marketing reasons or otherwise, the one or more quote providers 304 might be incentivized to provide unreliable (e.g., misleadingly low) quotes when comparison shopping is detected. As such, the process described herein may endeavor to ensure that synthetic user profiles cannot be easily distinguished from real user data.

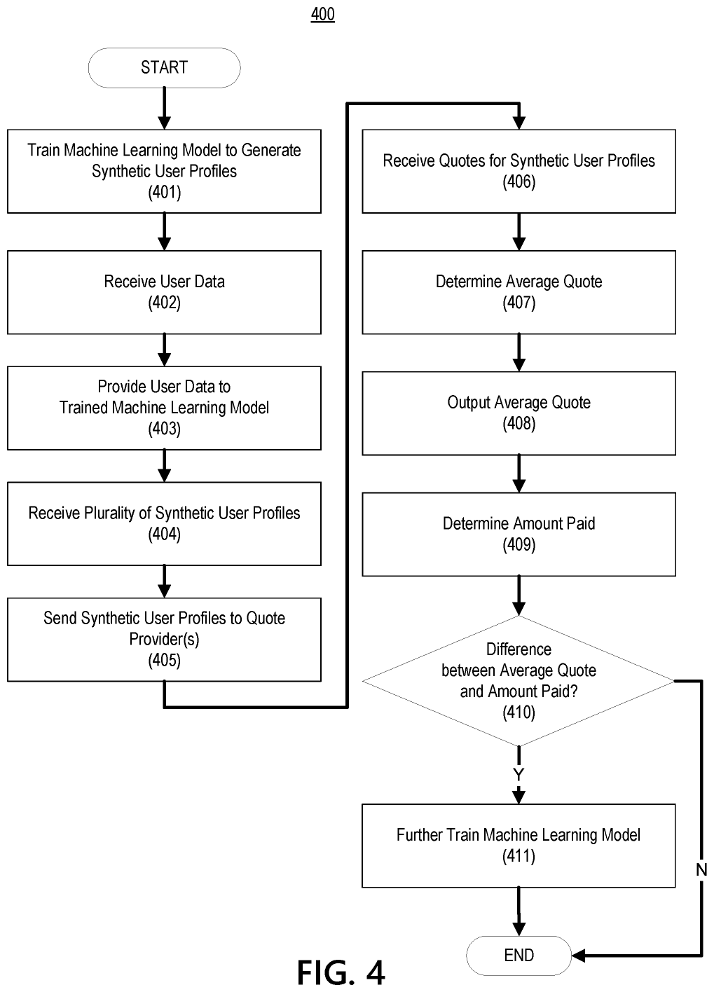

FIG. 4 depicts a flow chart depicting a method 400 comprising steps which may be performed to synthetically test quote providers to avoid disclosing user information. A computing device may comprise one or more processors and memory storing instructions that, when executed by the one or more processors, cause performance of one or more of the steps of FIG. 4. One or more non-transitory computer-readable media may store instructions that, when executed by one or more processors of a computing device, cause the computing device to perform one or more of the steps of FIG. 4. Additionally and/or alternatively, one or more of the devices depicted in FIG. 3, such as the one or more servers 301 and/or the one or more user devices 303, may be configured to perform one or more of the steps of FIG. 4. For simplicity, the steps below will be described as being performed by a single computing device; however, this is merely for simplicity, and any of the below-referenced steps may be performed by a wide variety of computing devices, including multiple computing devices.

In step 401, the computing device may train a machine learning model (e.g., a machine learning model as described with respect to FIG. 2, and/or as implemented via the one or more machine learning servers 302a) to generate synthetic user profiles. This process might involve training data involving user data. For example, the computing device may train, based on training data that comprises a plurality of different sets of user data, a machine learning model to generate synthetic user profiles by modifying, based on the training data, weights associated with one or more nodes of an artificial neural network. In such a way, based on being provided training data that provides information about a variety of users, the machine learning model may be able to determine inferences and correlations which permit it to output, in response to input, synthetic variations on such user data. In some cases, the training data might also include information about synthetic user profiles. For example, the training data may be labeled to indicate whether each of the plurality of different sets of user data represents a real person. In this manner, the machine learning model may be trained with data tagged as real user data and data tagged as synthetic, and might thereby learn how to generate synthetic user data based on the difference between that synthetic user data and corresponding real user data.

To train the machine learning model to make variations of real-world data, the machine learning model may be configured to identify similar users. For example, the training data provided to the trained machine learning model may comprise twenty different entries indicating that individuals of a particular age and in a particular city tend to have certain types of vehicles. In turn, when later provided with real user data (e.g., a new individual of the particular age in the particular city), the trained machine learning model may be configured to output a profile that indicates one or more of the types of vehicles. In this manner, the trained machine learning model might output synthetic user profiles that substantially mimic real-world data and that are believable.

In some cases, the machine learning model may comprise a Gaussian Mixture Model, a Generative Adversarial Network (GAN), and/or similar unsupervised machine learning models. A Gaussian Mixture Model may be configured to treat each feature of the training data (e.g., age, location) like a Gaussian distribution and may thereby learn parameters (e.g., mean, variance) from the training data. From such a process, the Gaussian Mixture Model may be resampled to generate synthetic user profiles. In the context of GANs, two or more neural networks may be used to generate possible data samples by optimizing an adversarial loss objective. Such data samples may additionally and/or alternatively be used to generate synthetic user profiles. In the case of GANs and/or Gaussian Mixture Models, the machine learning model may be trained such that, when provided with specific input (e.g., real user data and a noise seed), the models would be configured to output (e.g., sampled to output) a synthetic user profile. In these and similar unsupervised machine learning approaches, the machine learning models may thereby be trained to not explicitly label data, but instead to match an input distribution.

In step 402, the computing device may receive user data from a real user. For example, the computing device may receive first user data corresponding to a first user. In this manner, a user might provide, to the computing device, their real information that might ultimately be used to determine a quote from a quote provider. That said, as will be detailed below, this process may be performed in a manner whereby this real user data is not provided to the quote providers, but is instead used as the basis for generating synthetic user information.

In step 403, the computing device may provide user data to the trained machine learning model. For example, the computing device may provide, to the trained machine learning model, input comprising the first user data. Such a process may involve formatting and/or otherwise modifying the user data as necessary. For instance, particularly private aspects of the user data (e.g., Social Security numbers) might be removed, whereas largely irrelevant personal information (e.g., the apartment number of an individual living in an apartment complex) might be randomized.

In step 404, the computing device may receive a plurality of synthetic user profiles. These synthetic user profiles might be output from the trained machine learning model. For example, the computing device may receive, from the trained machine learning model, output comprising a plurality of different synthetic user profiles. Each of those plurality of different synthetic user profiles may comprise a variation of one or more properties of the first user data. For example, each synthetic user profile might have distinction from the real user data in some way: one might involve a different age, another might involve a different home or vehicle, another might indicate a different city, or the like. Such variance is intentional to preserve the privacy of the user and, because such variance is done in large quantities, the average of quotes based on these varied synthetic user profiles may nonetheless be usable to determine an accurate quote.

The synthetic user profiles may comprise a wide variety of information, including combinations of real user data and synthetic data. Indeed, it may be desirable to mix real information about a user that is not particularly sensitive (e.g., the user's age, the city they live in) with synthetic information that is more sensitive (e.g., the user's home address, the user's credit score). For example, each of the different synthetic user profiles may comprise an identification of a vehicle that is synthetic, an identification of an income level that is synthetic, and/or an identification of a geographic location that is real. Moreover, as indicated above, the synthetic user profiles may comprise data that is based on associations made based on the training data. For example, a synthetic indication of a vehicle might be based on a learning, by the trained machine learning model, that a user of a certain age and gender is likely to own the vehicle.

Generally, the information included might be based on the quote requested. For example, a car insurance quote might require personal data that identifies a car to be insured, whereas a house loan quote might require an address of a home, a number of bathrooms, and the like. The differences may pertain to personal information of a user. For example, a first synthetic user profile might comprise a first address different from a second address indicated in the first user data, a first income level different from a second income level indicated in the first user data, and/or a first traffic infraction history different from a second traffic infraction history indicated in the first user data.

To further preserve privacy, the computing device may perform one or more additional steps to obfuscate information in the plurality of synthetic user profiles. For example, the computing device may replace, in the plurality of different synthetic user profiles, instances of a name of the first user with a second name. As another example, information that is not particularly necessary for the quote provider (e.g., the user's IP address) might be removed from the synthetic user profiles. As yet another example, e-mail address information in the synthetic user profiles may be inserted and/or replaced with a catch-all e-mail address that directs any correspondence (e.g., unwanted marketing correspondence) to a particular inbox (e.g., one not actually affiliated with the user in question).

In step 405, the computing device may send the plurality of synthetic user profiles to one or more quote providers (e.g., the one or more quote providers 304 of FIG. 3). This may be performed via an API. For example, the computing device may send, via an API associated with a quote provider, each of the plurality of different synthetic user profiles to the quote provider.

The computing device may obfuscate transmission of the synthetic user profiles to the one or more quote providers. This may be desirable because it may prevent the one or more quote providers from determining which transmissions relate to real users and synthetic users, thereby aiding in the likely accuracy of the quotes provided. This may be effectuated in a variety of ways. The synthetic user profiles may be varied in time. For example, the computing device may send each of the plurality of different synthetic user profiles to the quote provider at a different time. As another example, the computing device may send batches of user profiles, with some being real and others being synthetic. The synthetic user profiles may additionally and/or alternatively be varied in quality. For example, the computing device may vary the quality of data from transmission to transmission by omitting certain data or modifying the format of certain data. The synthetic user profiles may additionally and/or alternatively be varied in transmission. For example, some of the synthetic user profiles may be transmitted via an API, whereas others might be transmitted through a web interface (e.g., by auto filling a form on a website associated with a quote provider).

In step 406, the computing device may receive, from the one or more quote providers, quotes for the synthetic user profiles. For example, the computing device may receive, from the quote provider and via the API, a plurality of different quotes that each correspond to a different one of the plurality of different synthetic user profiles. The quotes may provide a variety of detail, such as an identity of a user (whether real or synthetic), a periodic payment amount (e.g., a monthly payment), a deductible amount, or the like.

In step 407, the computing device may determine an average quote based on the quotes received in step 406. The average quote may be determined in a manner that averages one or more aspects of the quotes and which reflects the fact that the quotes are based on synthetic user profiles that are designed to be, in some ways, different from the real user data. For example, the computing device may determine an average quote for the first user based on deviations between each of the plurality of different synthetic user profiles and the first user data and the plurality of different quotes. In this way, the average quote is designed to, as best as possible, approximate a quote as if the user provided their real information to the one or more quote providers.

Determining the average quote may comprise weighting quotes based on, e.g., how different their corresponding synthetic user profile is from real user data. In this manner, quotes based on radically different synthetic user profiles might be weighted to be of less pertinence for an average quote as compared to quotes based on fairly similar synthetic user profiles. For example, the computing device may determine, based on the deviations, a weight for each of the plurality of different quotes and generate a weighted plurality of different quotes by multiplying each of the plurality of different quotes by a corresponding weight. Then, the computing device may sum the weighted plurality of different quotes.

In turn, the weighting might be performed based on a distance of one or more synthetic profiles from real-world data. For example, assume that first synthetic user data indicates a 34-year-old woman driving a sedan, and second synthetic user data indicates a 35-year-old woman driving a truck. As compared to real-world data indicating a 33-year-old woman trying to insure a sedan, the first synthetic user data might be considered to be closer to the real user (and therefore provided a more significant weight) because the ages are closer and the vehicles are similar. Such distance might be measured using Euclidean distance between numerical features. For example, the system might calculate the Euclidean distance between the numerical features of the profile and the customer and use their inverse distances as weight values for the purposes of determining an average quote. In such an example, those weights might be normalized (e.g., the sum of the weights may be 1).

To provide an example of how the above might be mathematically calculated in certain circumstances, assume profile p has a quote q that has a Euclidean distance d from a real-world user's features, and that N synthetic user profiles are generated. In such a case, the normalization factor M may comprise the sum of 1/dᵢ for an i of 1 to N. In such an example, the weighting scheme may thereby become:

$$Weighted Average = {W}_{1} {q}_{1} + {W}_{2} {q}_{2} + … {W}_{N} {Q}_{N} where {W}_{n} = \frac{1}{{Md}_{n}}$$

The weights may be corrected using bias and/or error correction. For instance, the process described herein may be performed over time, and a database may store a large plurality of synthetic user profiles, average quotes, actual amounts paid by users, and the like. This data may be used as a training set for a linear regression, which might indicate one or more bias term(s) to offset the machine learning model to add correction. In this manner, over time, the data described herein may be used to improve the machine learning model through error correction.

Determining the average quote might be performed using linear regression. A linear regression algorithm may be provided data including the synthetic user profiles (e.g., each variable of the synthetic user profiles or a subset thereof) and corresponding quotes for each of the synthetic user profiles. In turn, the algorithm may output a model (e.g., a formula with weights) representing the quotes. That formula may be provided, as input, the real user data, and the result of the formula may comprise the average quote.

One way to determine the average quote might be by modeling the data as Gaussian. Such an approach may provide an assumption where using maximum likelihood estimation has validity. The output of the trained machine learning model may be modeled as the true estimate of the cost with Gaussian noise. In this manner, when multiple outputs of the trained machine learning model are averaged, an optimal mean estimate can be determined (e.g., using the maximum likelihood estimation algorithm). In this manner, using the Gaussian assumption, the average quote might be determined via statistics of a Gaussian curve determined based on the output of the trained machine learning model. For example, the average quote might be determined (within a 95.44% confidence) to be a range of two standard deviations from the mean of the Gaussian curve.

Step 408 through step 411 begin a process whereby the system may further train the already-trained machine learning model based on learning of the actual amount paid by a user. The fact that a user might have paid a different amount than the average quote may provide evidence that some aspect of the machine learning model (that is, some aspect of the various synthetic user profiles it generates) is not sufficiently accurate for the purposes of determining an average quote. For example, due to limitations in the training data, the trained machine learning model may inadvertently create synthetic user profiles that are too different than the user data, which might in turn create too much undesirable variance in the quotes for the synthetic user profiles, which might in turn result in an inaccurate and/or otherwise unreliable average quote. The process described in step 408 through step 411 is intended, in part, to help address this concern by ensuring that the trained machine learning model can learn from mistakes.

In step 408, the computing device may output the average quote determined in step 407. This output may be performed via user interface, such as one that might be displayed by the one or more user devices 303. For example, the computing device may cause display, in a user interface, of the average quote.

In step 409, the computing device may determine an amount paid by a user. The amount paid by the user may comprise an actual amount paid by the user (e.g., on a periodic basis, in total) for the good and/or service to which the average quote pertains. In some cases, the average quote might have been wrong, and thus there may be a difference between the average quote and the amount actually paid by a user. For example, the computing device may receive, via the user interface, a difference between the average quote and an amount paid to the quote provider.

Determining the amount paid by a user (and/or any differences between it and the average quote) may entail transaction data processing. The computing device might be configured to identify transactions corresponding to the good and/or service to which the average quote pertains, and thus infer the actual amount paid by the user for that good and/or service. For example, the computing device may receive, from a transactions database (e.g., as stored by the one or more transaction servers 302b), a transactions history corresponding to the first user and parse the transactions history to identify at least one transaction corresponding to the quote provider. The computing device may then determine, based on the at least one transaction, the actual amount paid by the user and to the quote provider.

Determining the amount paid by a user (and/or any differences between it and the average quote) may entail e-mail processing. The computing device might be configured to identify e-mails corresponding to the good and/or service to which the average quote pertains, and thus infer the actual amount paid by the user for that good and/or service. For example, the computing device may process one or more e-mails of an e-mail account of a user to identify e-mails associated with the good and/or service. Then, the computing device might identify, based on those e-mails and using, e.g., natural language processing, an amount actually paid by the user.

Determining the amount paid by a user (and/or any differences between it and the average quote) may entail receiving information about the amount paid by the user via a user interface. In this manner, the user might directly provide the information to the computing device via, for instance, a user interface. For example, the computing device may receive, via the user interface and from the first user, input comprising the actual amount paid by the user and to the quote provider.

In step 410, the computing device may determine whether a difference between the average quote determined in step 407 and the amount paid determined in step 409 satisfies a threshold. The threshold might be based on an amount that indicates that the machine learning model provided incorrect and/or somehow misleading synthetic user profiles. For example, for a home loan, the difference of a few dollars might be inconsequential and largely the result of small fees or other minutiae, suggesting that the average quote was largely correct. That said, for car insurance, the difference of tens of dollars might be significant and indicate that the average quote (and thus, potentially, the synthetic user profiles) had errors. If the difference satisfies a threshold, the method 400 proceeds to step 411. Otherwise, the method 400 ends.

In step 411, the computing device may further train the machine learning model based on the difference from step 410. In this manner, the computing device may train the machine learning model to generate synthetic user profiles that better emulate the real user and thus potentially result in a more accurate average quote. For example, the computing device may provide, as further training to the trained machine learning model, data based on the difference between the average quote and an amount paid to the quote provider.

In addition to and/or alternatively to step 411, the one or more weights used as part of the determination of the average quote may be modified. For example, in the case where linear regression is used to determine a model, the weights of the linear regression may be modified based on the difference. For example, if age was weighted with a weight value of 0.5, if the difference was significant, the weight value might be lessened or increased.

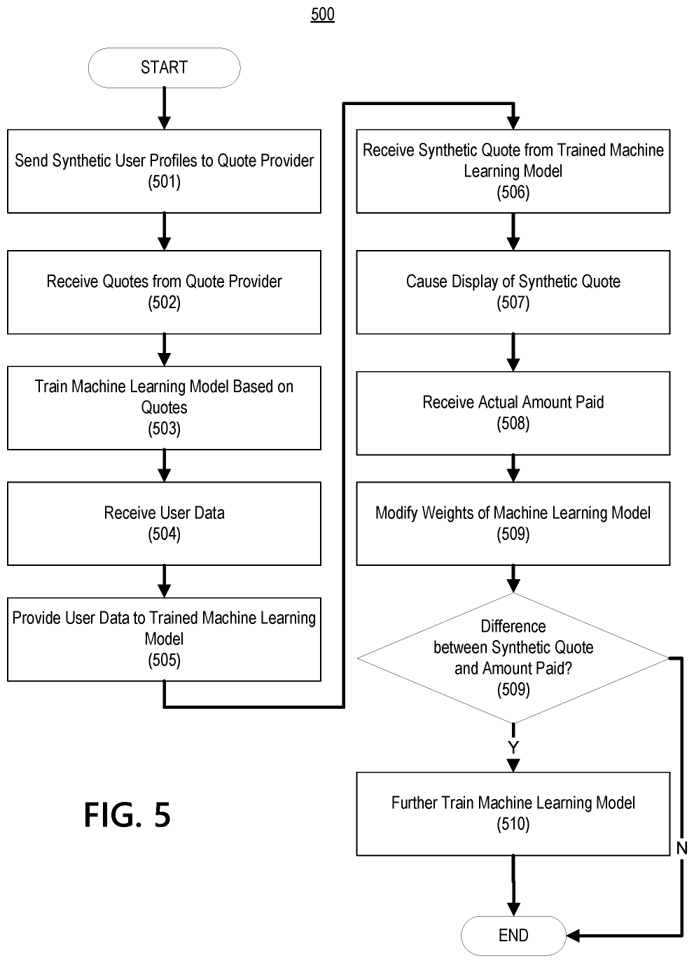

Discussion will now turn to use of a different machine learning model for the purposes of synthetic quote generation. Such a process might occur in conjunction with the processes described with respect to FIG. 4. In other words, in some circumstances, two different trained machine learning models might be implemented: one might be used for the purposes of generating synthetic user profiles to provide quote providers (as detailed with respect to FIG. 4), whereas another (detailed below with respect to FIG. 5) might be used to generate synthetic quotes based on real-world quotes received from those quote providers.

FIG. 5 depicts a flow chart depicting a method 500 comprising steps which may be performed to implement an artificial intelligence model of quote providers. A computing device may comprise one or more processors and memory storing instructions that, when executed by the one or more processors, cause performance of one or more of the steps of FIG. 5. One or more non-transitory computer-readable media may store instructions that, when executed by one or more processors of a computing device, cause the computing device to perform one or more of the steps of FIG. 5. Additionally and/or alternatively, one or more of the devices depicted in FIG. 3, such as the one or more servers 301 and/or the one or more user devices 303, may be configured to perform one or more of the steps of FIG. 5. For simplicity, the steps below will be described as being performed by a single computing device: however, this is merely for simplicity, and any of the below-referenced steps may be performed by a wide variety of computing devices, including multiple computing devices.

In step 501, the computing device may send synthetic user profiles to a quote provider. For example, the computing device may send, to a quote provider, a plurality of different synthetic user profiles generated based on one or more real user profiles. The synthetic user profiles may have been generated based on the process described with respect to step 401 through step 404 of FIG. 4. Moreover, like step 405 of FIG. 4, the synthetic user profiles might be sent via an API and/or any other method, and might be varied in transmission so as to obfuscate the distinction between real users and synthetic user profiles.

In turn, as part of step 501, the computing device may train the machine learning model to generate synthetic user profiles. For example, the computing device may train a second machine learning model to generate synthetic user profiles, provide, to the trained second machine learning model, input comprising second user data, and receive, from the trained second machine learning model, output comprising the synthetic user profile.

In step 502, the computing device may receive quotes from the quote provider. This step may be the same or similar as step 406 of FIG. 4. For example, the computing device may receive, from the quote provider, a plurality of different quotes that each correspond to a different one of the plurality of different synthetic user profiles.

In step 503, the computing device may train a machine learning model based on the quotes received in step 502. In this way, a machine learning model may be trained using both the synthetic user profiles and the corresponding quotes to generate a model that predicts quotes for that quote provider based on a number of variables. For example, the computing device may train, based on training data that comprises the plurality of different quotes and the plurality of different synthetic user profiles, a machine learning model to estimate quotes by modifying, based on the training data, weights associated with one or more nodes of an artificial neural network. In practice, such a model might be configured to take specific inputs (e.g., in the case of a car loan quote provider, car make, car model, car year, and credit score) and provide specific output (e.g., a synthetic quote).

In step 504, the computing device may receive user data. This step may be the same or similar a step 402 of FIG. 4. For example, the computing device may receive first user data corresponding to a first user.

In step 505, the computing device may provide the user data received in step 504 to the trained machine learning model. For example, the computing device may provide, to the trained machine learning model, input comprising the first user data. The user data might be provided via one or more input notes of the trained machine learning model.

The user data may be pre-processed and/or otherwise modified before being provided to the trained machine learning model. For example, to prevent the inadvertent use of particularly private information by the machine learning model as part of generating synthetic quotes, data such as social security numbers might be removed from the user data. As another example, the user data may be scaled, formatted, and/or otherwise modified for consistency based on a formatting of the training data (e.g., the formatting of the synthetic user profiles and/or the quotes used to train the machine learning model in step 503) to avoid any unexpected output from the trained machine learning model.

In step 506, the computing device may receive, from the trained machine learning model, a synthetic quote. For example, the computing device may receive, from the trained machine learning model, output comprising a synthetic quote. A synthetic quote may comprise a prediction, by the trained machine learning model, of a quote that would be received by the quote providers referenced in step 501. For example, if the quotes received in step 502 were all from Company A, then the synthetic quote received in step 506 may comprise a prediction of what sort of quote would be provided by Company A if the user data received in 504 were directly transmitted to Company A as part of a request for a quote.

In step 507, the computing device may cause display of the synthetic quote. For example, the computing device may cause display, in a user interface, of the synthetic quote. This may comprise causing output of the synthetic quote in a user interface, such as in an application executing on the one or more user devices 303 or the like. The synthetic quote may comprise various information about a quote that might be provided by a quote provider, such as a predicted periodic payment amount. Along those lines, the synthetic quote may have similar aspects as if the quote were real: it might indicate (as applicable) information such as a payment period, a monthly payment, an effective time period, an insured object (e.g., the house/automobile to be insured), a mileage limit, or the like.

Step 508 and step 509 begin discussion of a process whereby the trained machine learning model may be improved based on real-world quotes. Broadly, it may be desirable to continually re-train the trained machine learning model based on whether it provided an accurate synthetic quote. In other words, when data is received as to what a user actually might have paid (and/or the actual quote by a quote provider), such information is particularly valuable because it can be used to determine whether the machine learning model is operating accurately.

In step 508, the computing device may receive an actual amount paid by a user. This step may be similar to step 409 of FIG. 4. For example, the computing device may receive data indicating an actual amount paid by the user and to the quote provider.

In step 509, the computing device may determine whether a difference between the synthetic quote received in step 506 and the amount paid determined in step 508 satisfies a threshold. In some circumstances, the actual amount paid by the user may be different from an amount indicated by the synthetic quote. For example, due to limitations of the training data or the unexpected importance of some specific variable of user data (e.g., the fact that a brand new car is known to be unsafe and thus might be associated with a particularly high insurance payment), the actual amount paid might be significantly different than the synthetic quote. The threshold might be based on an amount that indicates that the machine learning model provided incorrect and/or somehow misleading synthetic quote. For example, the threshold might be ten dollars, such that the machine learning model might have provided an incorrect synthetic quote if it provided a synthetic quote that was different from the actual amount paid by ten dollars or greater. If the difference satisfies a threshold, the method 500 proceeds to step 510. Otherwise, the method 500 ends.

In step 510, the computing device may modify the weights of the machine learning model. In this manner, the trained machine learning model may be further trained based on the difference between the synthetic quote and the amount paid. For example, the computing device may modify, based on the actual amount paid by the user and to the quote provider, the weights associated with the one or more nodes of the artificial neural network.

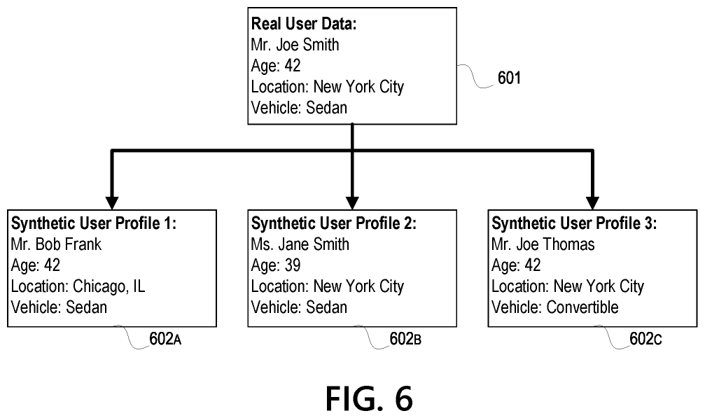

FIG. 6 depicts examples of how real user data might be used to create one or more synthetic user profiles. Specifically, FIG. 6 shows real user data 601, which indicates a real name (Joe Smith), an age (42), a location (New York City), and a vehicle (a sedan). In turn, FIG. 6 also shows three illustrative synthetic user profiles: a first synthetic user profile 602a, a second synthetic user profile 602b, and a third synthetic user profile 602c. Each of these synthetic user profiles is different from the real user data 601. For example, the first synthetic user profile 602a uses a different name (Bob Frank) and a different location (Chicago, IL), the second synthetic user profile 602b uses a different name (Jane Smith) and a different age (39), and the third synthetic user profile 602c uses a different name (Joe Thomas) and a different vehicle (a convertible).

The differences in the synthetic user profiles shown in FIG. 6 might be used to ascertain an average quote for a user corresponding to the real user data 601. Assume, for example, that, when provided to a quote provider, the first synthetic user profile 602a was provided a quote of $50, the second synthetic user profile 602b was provided a quote of $55, and the third synthetic user profile 602c was provided a quote of $70. In this circumstance, the average quote may be $58.33. That said, weighting might be considered: for example, because vehicle type might be particularly important for the purposes of determining a car insurance rate, the quote for the third synthetic user profile 602c might be weighted to a lesser degree than other quotes received. In that circumstances, the average quote might be somewhat less than the aforementioned $58.33.

In practice, a large quantity of different synthetic user profiles may be used, which may in turn create a much more varied dataset from which to determine an average quote. For example, hundreds of different synthetic user profiles might be generated based on the real user data 601, such that hundreds of different data points may be used. In this way, different analytical methods, such as linear regression tactics, might be used to determine a function of average quote based on various factors (e.g., age, location, vehicle, and the like).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to synthetically test quote providers to avoid disclosing user information, the computing device comprising:
one or more processors; and
memory storing instructions that, when executed by the one or more processors, cause the computing device to:
train, based on training data that comprises a plurality of different sets of user data, a machine learning model to generate synthetic user profiles by modifying, based on the training data, weights associated with one or more nodes of an artificial neural network;
receive first user data corresponding to a first user:
provide, to the trained machine learning model, input comprising the first user data;
receive, from the trained machine learning model, output comprising a plurality of different synthetic user profiles, wherein each of the plurality of different synthetic user profiles comprises a variation of one or more properties of the first user data:
send, via an Application Programming Interface (API) associated with a quote provider, each of the plurality of different synthetic user profiles to the quote provider;
receive, from the quote provider and via the API, a plurality of different quotes that each correspond to a different one of the plurality of different synthetic user profiles;
determine an average quote for the first user based on:
deviations between each of the plurality of different synthetic user profiles and the first user data; and
the plurality of different quotes; and
cause display, in a user interface, of the average quote.

2. The computing device of claim 1, wherein the instructions, when executed, further cause the computing device to:
replace, in the plurality of different synthetic user profiles, instances of a name of the first user with a second name.

3. The computing device of claim 1, wherein the instructions, when executed, further cause the computing device to:
receive, via the user interface, a difference between the average quote and an amount paid to the quote provider; and
provide, as further training to the trained machine learning model, data based on the difference.

4. The computing device of claim 1, wherein the instructions, when executed, further cause the computing device to send the each of the plurality of different synthetic user profiles to the quote provider by causing the computing device to:
send each of the plurality of different synthetic user profiles to the quote provider at a different time.

5. The computing device of claim 1, wherein the instructions, when executed, further cause the computing device to determine the average quote for the first user by causing the computing device to:
determine, based on the deviations, a weight for each of the plurality of different quotes;
generate a weighted plurality of different quotes by multiplying each of the plurality of different quotes by a corresponding weight; and
sum the weighted plurality of different quotes.

6. The computing device of claim 1, wherein at least one of the plurality of different synthetic user profiles comprises one or more of:
a first address different from a second address indicated in the first user data;
a first income level different from a second income level indicated in the first user data: or
a first traffic infraction history different from a second traffic infraction history indicated in the first user data.

7. The computing device of claim 1, wherein the training data is labeled to indicate whether each of the plurality of different sets of user data represents a real person.

8. A method for synthetically testing quote providers to avoid disclosing user information, the method comprising:
training, based on training data that comprises a plurality of different sets of user data, a machine learning model to generate synthetic user profiles by modifying, based on the training data, weights associated with one or more nodes of an artificial neural network;
receiving first user data corresponding to a first user;
providing, to the trained machine learning mode, input comprising the first user data;
receiving, from the trained machine learning model, output comprising a plurality of different synthetic user profiles, wherein each of the plurality of different synthetic user profiles comprises a variation of one or more properties of the first user data;
sending, via an Application Programming Interface (API) associated with a quote provider, each of the plurality of different synthetic user profiles to the quote provider;
receiving, from the quote provider and via the API, a plurality of different quotes that each correspond to a different one of the plurality of different synthetic user profiles;
determining an average quote for the first user based on:
deviations between each of the plurality of different synthetic user profiles and the first user data; and
the plurality of different quotes; and
causing display, in a user interface, of the average quote.

9. The method of claim 8, further comprising:
replacing, in the plurality of different synthetic user profiles, instances of a name of the first user with a second name.

10. The method of claim 8, further comprising:
receiving, via the user interface, a difference between the average quote and an amount paid to the quote provider; and
providing, as further training to the trained machine learning model, data based on the difference.

11. The method of claim 8, wherein sending the each of the plurality of different synthetic user profiles to the quote provider comprises:
sending each of the plurality of different synthetic user profiles to the quote provider at a different time.

12. The method of claim 8, wherein determining the average quote for the first user comprises:
determining, based on the deviations, a weight for each of the plurality of different quotes;
generating a weighted plurality of different quotes by multiplying each of the plurality of different quotes by the weight; and
summing the weighted plurality of different quotes.

13. The method of claim 8, wherein at least one of the plurality of different synthetic user profiles comprises one or more of:
a first address different from a second address indicated in the first user data;
a first income level different from a second income level indicated in the first user data: or
a first traffic infraction history different from a second traffic infraction history indicated in the first user data.

14. A computing device configured to implement an artificial intelligence model of quote providers, the computing device comprising:
one or more processors; and
memory storing instructions that, when executed by the one or more processors, cause the computing device to:
send, to a quote provider, a plurality of different synthetic user profiles generated based on one or more real user profiles;
receive, from the quote provider, a plurality of different quotes that each correspond to a different one of the plurality of different synthetic user profiles:
train, based on training data that comprises the plurality of different quotes and the plurality of different synthetic user profiles, a machine learning model to estimate quotes by modifying, based on the training data, weights associated with one or more nodes of an artificial neural network;
receive first user data corresponding to a first user;
provide, to the trained machine learning model, input comprising the first user data;
receive, from the trained machine learning model, output comprising a synthetic quote;
cause display, in a user interface, of the synthetic quote;
receive data indicating an actual amount paid by the user and to the quote provider; and
modify, based on the actual amount paid by the user and to the quote provider, the weights associated with the one or more nodes of the artificial neural network.

15. The computing device of claim 14, wherein the instructions, when executed, further cause the computing device to receive the data indicating the actual amount paid by the user and to the quote provider by causing the computing device to:
receive, from a transactions database, a transactions history corresponding to the first user;
parse the transactions history to identify at least one transaction corresponding to the quote provider; and
determine, based on the at least one transaction, the actual amount paid by the user and to the quote provider.

16. The computing device of claim 14, wherein the instructions, when executed, further cause the computing device to receive the data indicating the actual amount paid by the user and to the quote provider by causing the computing device to:
receive, via the user interface and from the first user, input comprising the actual amount paid by the user and to the quote provider.

17. The computing device of claim 14, wherein the instructions, when executed, further cause the computing device to:
train a second machine learning model to generate synthetic user profiles;
provide, to the trained second machine learning model, input comprising second user data; and
receive, from the trained second machine learning model, output comprising the synthetic user profile.

18. The computing device of claim 14, wherein the synthetic quote indicates a predicted periodic payment amount.

19. The computing device of claim 14, wherein the actual amount paid by the user and to the quote provider is different from an amount indicated by the synthetic quote.

20. The computing device of claim 14, wherein each of the plurality of different synthetic user profiles comprises one or more of:
an identification of a vehicle;
an identification of an income level; or
an identification of a geographic location.
